(19) United States
(12) Patent Application Publication
(10) Pub. No.: US 2013/0185768 A1
(43) Pub. Date: Jul. 18, 2013

(54) Monetization of a Media Channel Network

(71) Applicants: Pierre C. Barbeau, Leawood, KS (US); James D. Barnes, Overland Park, KS (US); Kurt Iverson, Olathe, KS (US)

(72) Inventors: Pierre C. Barbeau, Leawood, KS (US); James D. Barnes, Overland Park, KS (US); Kurt Iverson, Olathe, KS (US)

(21) Appl. No.: 13/467,819

(22) Filed: May 9, 2012

Related U.S. Application Data
(60) Provisional application No. 61/588,063, filed on Jan. 18, 2012.

(51) Int. Cl. G06F 21/00; G06F 15/16

(52) U.S. Cl. 726/4

(57) ABSTRACT

The disclosed embodiments relate to a media or communication network or platform that facilitates communication via one or more media or communication channels. Moreover, the disclosed embodiments allow one or more third-party content sources to determine how their content is transmitted or conveyed, when their content is transmitted or conveyed, and/or which channels should be used to transmit or convey their content. One or more third-party content sources may, for instance, target one or more specific channels based on, for example, the one or more channel operators, the audience of the one or more channels, or the like. This allows one or more third-party content sources to leverage their content against channel operators or content from other third-party content sources. One or more third-party content sources may, for example, bid against other third-party content sources for the ability to transmit or convey their content via the one or more channels.

### REFERENCE TO RELATED APPLICATIONS

This application claims the benefit of the filing date under 35 U.S.C.§ 119(e) of U.S. Provisional Application Ser. No. 61/588,063, filed Jan. 18, 2012, which is hereby incorporated by reference in its entirety.

### BACKGROUND

Content platforms may generally include computer based systems that distribute, present, or transmit information or content, such as advertisements, coupons, entertainment, descriptions, schedules, etc., from content producers, publishers, or providers to content end users. A content platform may, for instance, be used as a marketing or advertising platform or network to facilitate the transmission or distribution of advertisements for products or services from, for example, a third-party content producer, provider, or publisher. Marketing or advertising platforms may, for instance, facilitate the transmission of product or service advertising to mobile phone users, such as via, for example, short message service (SMS) messages, proprietary mobile applications, or web pages, such as via mobile web browser programs. U.S. Pat. No. 7,343,317 and U.S. Patent Publication No. 2008/0120186, for example, describe a marketing platform for mobile devices in which advertising messages are dynamically transmitted to registered mobile phone users located in or in the vicinity of a specified location. The content of the advertising messages (e.g., the monetary value of an offer or promotional message) may vary depending on, for example, the number of mobile phone users in the area. Other examples of such networks include Apple's iAd Network and Google's AdMob Network. Apple's iAd Network, for example, operates as follows: a third-party content producer develops or creates an advertisement, a creator of a registered iPad, iPhone, and/or iTunes application inserts the required code in his/her application and gives Apple permission to insert the advertisement submitted by the third-party content producer in exchange for a specified fee, and Apple displays the advertisement within, or during use of, the application.

Generally, content platforms facilitate communication of content from a content provider to a plurality of content consumers (e.g., end users).

### BRIEF DESCRIPTION OF THE DRAWINGS

The examples of the invention described below can be better understood with reference to the following figures. The components in the figures are not necessarily to scale, emphasis instead being placed upon illustrating the principles of the invention. In the figures, like reference numerals designate corresponding parts throughout the different views.

FIG. 1 depicts an exemplary communication network.

FIG. 2 depicts a block diagram of an example of a system for facilitating the leveraging of a first channel and a second channel of the communication network shown in FIG. 1.

FIG. 3 depicts a flow chart showing operation of the system in FIG. 2.

FIG. 4 depicts an exemplary computer system for use with the system of FIG. 2.

FIG. 5 is a block diagram of another example of the system shown in FIG. 2.

FIG. 6 is a block diagram of another example of the system shown in FIG. 2.

FIG. 7 is a block diagram of another example of the system shown in FIG. 2.

FIG. 8 is a block diagram of another example of the system shown in FIG. 2.

FIG. 9 is a block diagram of another example of the system shown in FIG. 2.

### DETAILED DESCRIPTION OF THE DRAWINGS AND PRESENTLY PREFERRED EMBODIMENTS

The disclosed embodiments relate to a media or communication network, also referred to as a platform, that facilitates communication via one or more media or communication channels, as will be described. A “media channel,” or “channel,” may be defined as one or more communication media and identifiers, or other indicators, of recipients, or content receiving devices associated therewith or otherwise enabled to receive, content distributed via the one or more communication media and may include one or more end users or content consumers or subscribers, i.e., a “channel audience,” or “audience,” and may be further defined as one or more transmission conduits, i.e. media and suitable protocols for communicating thereby, operable to convey, transmit, or distribute information or content from a source to the channel audience, via one or more content receiving devices. The one or more media of a media channel may include a mobile or smart phone application, electronic mail (“email”), short message service (SMS) or multimedia message service (MMS), a webpage or website, an interactive venue (e.g., interactive kiosk, digital display), an electronic board or public presentation/display device (e.g. scoreboard), or the like. The channel may be associated with a channel operator that owns and/or operates or maintains, on behalf of the channel owner, the channel. The channel may be created by the channel operator, channel owner, a platform operator (e.g., Moblico LLC), or a combination thereof The information or content may be submitted, uploaded, shared, transmitted, or otherwise provided or communicated to the channel by one or more channel operators, one or more third-party content sources (e.g., third-part content producers, third-party content providers, third-party content publishers), or a combination thereof The one or more channel operators and/or third-party content sources may be individuals, and/or organizations (e.g., corporations, government organizations). The information or content may include news, events (e.g., sporting events), city, state, or municipal information (e.g., attractions, emergency information, etc.), product and/or service advertising or marketing (e.g., product or service information, store or restaurant listings, and/or financial incentives, such as coupons, rebates, discounts, or deals, associated with a particular product or service) and may be presented to the channel audience in the form of a screenshot, a webpage, an ad banner or window, scrolling text, an information page, or other image, audio, video, etc. The information or content may be distributed, transmitted, or otherwise provided, via the channels, to the one or more content receiving devices identified by the channel. The one or more content receiving devices present, display, or otherwise make available the content or information to the defined channel audience. The defined channel audience may include one or more channel subscribers, customers, users, subscribers or participants.

Known advertising or marketing platforms or content networks, such as those described above, are generally “one-to-many” systems that permit a content source to deliver content to a defined audience. However, such platforms do not give channel operators control over how, when, where, or what third-party content or information may be transmitted or conveyed via their channels in the advertising or marketing network. Instead, the channel operator only determines whether he/she wishes to participate in, and, thus, earn revenue from, the advertising platform or network. Once the channel operator registers to participate in the advertising network, the network or platform operator (e.g., Apple or Google) solicits advertisers and determines which advertisements will be conveyed via which registered channel. Channel operators are unable to communicate with third-party content sources and/or other channel operators to leverage their channels. Further, channel operators are unable to develop one-to-one or personal relationships with third-party content sources (e.g. providers, publishers, and/or producers) to leverage their channel and/or their own channel content and/or protect their brand, by, for example, excluding undesirable content or content from competing or undesirable third-party content sources.

Known advertising or marketing platforms or content networks also do not give third-party content sources, who wish to distribute, transmit, or convey their content or information, control over how, when, or where their content or information is distributed, transmitted, or conveyed via one or more channels in the advertising network. Instead, the third-party content source only determines whether he/she wishes to participate and, thus, pay to advertise in the advertising network. Once the third-party content source registers to participate in the advertising network, the network or platform operator finds registered channels and determines which advertisements will be conveyed via which registered channel. Third-party content sources are unable to communicate with other third-party content sources and/or channel operators. Third-party content sources are thus unable to develop one-to-one or personal relationships with channel operators and/or channels and/or target specific channels based on, for example, context, demographics to leverage their content (e.g., the channel has a predominately male audience), or location (e.g., the channel has a large audience in Chicago). This also prevents channel operators from expanding their channel audience by, for example, transmitting or distributing their content via other channels, e.g. channels belonging to other channel operators, that might have a compatible or demographically favorable channel audience.

Unlike known advertising or marketing platforms or content networks, the disclosed embodiments allow one or more channel operators to communicate with other channel operators and/or third-party content sources. The disclosed embodiments allow one or more channel operators, at their discretion, to control which third-party content is transmitted or conveyed via their one or more channels, how that content is conveyed or transmitted, when that content is conveyed or transmitted, and/or where, relative to other channel content, that content is conveyed or transmitted. The disclosed embodiments also allow one or more channel operators to filter one or more third-party content sources such that the one or more channel operators are given significant control over which of the one or more third-party content sources may provide content via their one or more channels. Accordingly, the disclosed embodiments give channel operators the ability to leverage their channels and/or their own channel content and/or the ability to protect their brand.

Moreover, the disclosed embodiments allow one or more third-party content sources to determine how their content is transmitted or conveyed, when their content is transmitted or conveyed, and/or which channels should be used to transmit or convey their content. One or more third-party content sources may, for instance, target one or more specific channels based on, for example, the one or more channel operators, the audience of the one or more channels (e.g., the channel has a predominately male audience and the channel content is sports related), or the like. This allows one or more third-party content sources to leverage their content against channel operators or content from other third-party content sources. One or more third-party content sources may, for example, bid against other third-party content sources for the ability to transmit or convey their content via the one or more channels.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superceding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

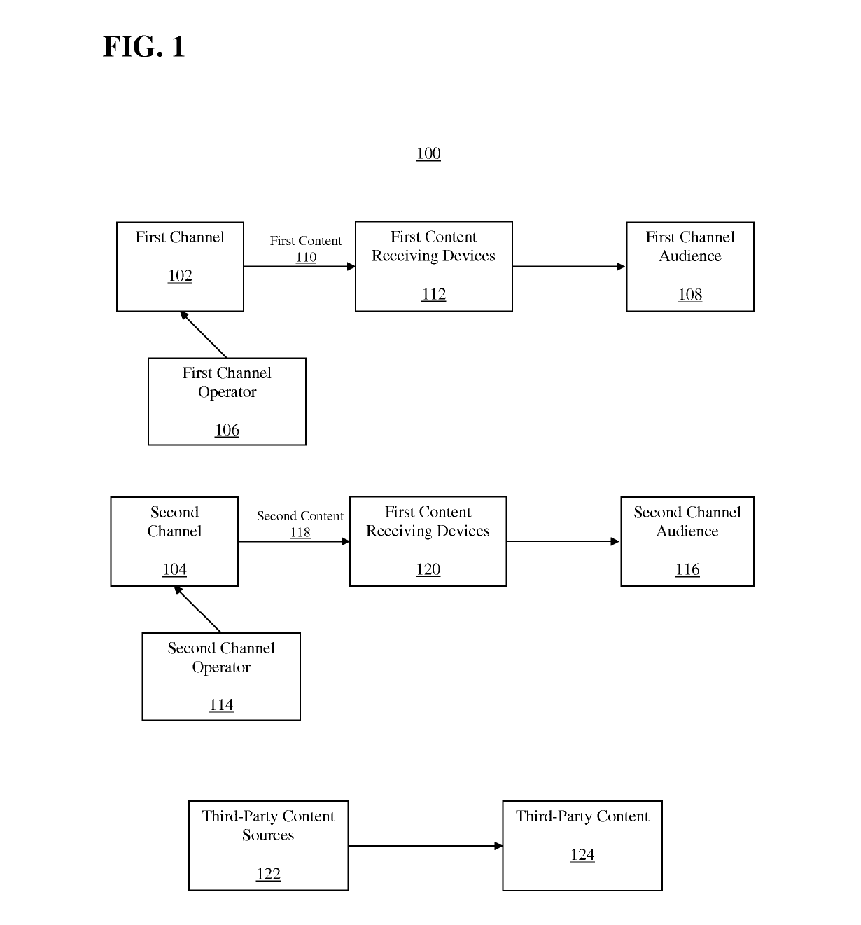

FIG. 1 shows a block diagram of a communication network 100 according to one embodiment. The communication network 100 includes a first channel 102 and a second channel 104. The first channel 102 is associated with a first channel operator 106 and has a defined first channel audience 108. The first channel 102 is operable to convey first content 110 to the first channel audience 108 via or by way of one or more first content receiving devices 112. The one or more first content receiving devices 112 present or display the first content 110 to the first channel audience 108. The second channel 104 is associated with a second channel operator 114 and has a defined second channel audience 116. The second channel 104 is operable to convey second content 118 to the second channel audience 116 via or by way of one or more second content receiving devices 120. The one or more second content receiving devices 120 present or display the second content 118 to the second channel audience 116.

The communication network 100 further includes a plurality of third-party content sources 122 (e.g. third-party content producers, publishers, and/or providers). As will be described below, one or more of the third-party content sources 122 may provide, publish, and/or produce third-party content 124 for transmission or distribution via the first channel 102 and/or the second channel 104. In other embodiments, the first channel operator 106 and/or the second channel operator 114 may also be a third-party content source 122. Likewise, one of the third-party content sources 122 may be the first channel operator 106 and/or the second channel operator 114. For example, the first channel operator 106 may be associated with the first channel 102 and convey first content 110 via the first channel 102, but may also provide, submit, or transmit second content 118 via the second channel 104, such that the first channel operator 106 is a third-party content source 122 with respect to the second channel 104.

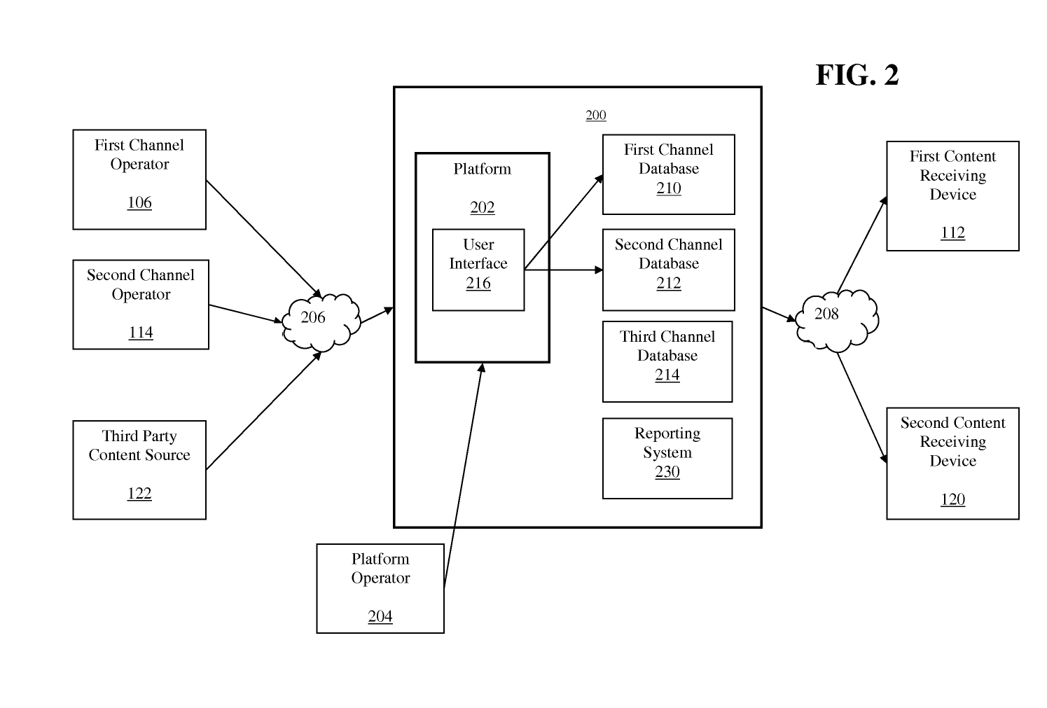

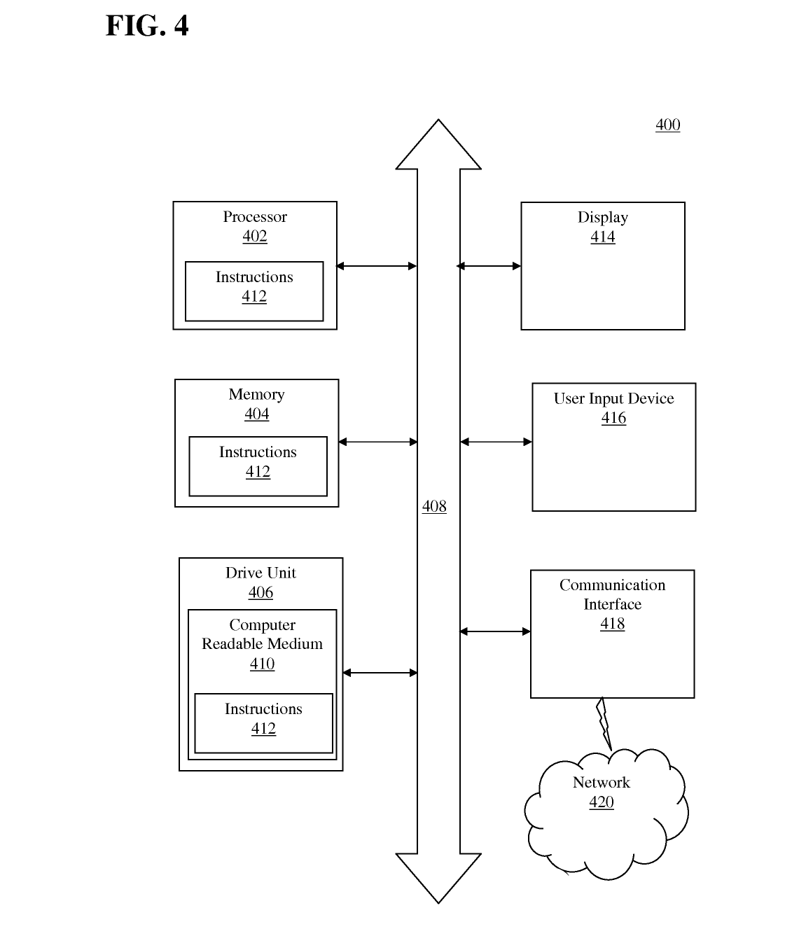

Referring to FIG. 2, there is shown a block diagram of one system 200 for facilitating the leveraging or monetization of the first and second channels 102, 104 in the communication network 100. The system 200 includes a communication platform or server 202 associated with a platform operator 204. The platform or server 202 is coupled with the channel operators 106, 114, and the third-party content sources 122 via a wired and/or wireless network 206. The platform 202 is also coupled with the one or more first content receiving devices 112 and the one or more second content receiving devices 120 via a wired and/or wireless network 208. In one embodiment, the network 206 may be the same as the network 208 (and vice-versa). Herein, the phrase “coupled with” is defined to mean directly connected to or indirectly connected through one or more intermediate components. Such intermediate components may include both hardware and software based components. In one embodiment, the platform 202 may be implemented as computer program logic or computer readable program code stored in the memory and/or storage of a computer, such as the computer 400 described below with respect to FIG. 4, and executable by one or more processors thereof to implement the disclosed functionality.

The system 200 also includes a first channel database 210 and a second channel database 212. The first channel database 210 may store or maintain identifiers or other indicators, such as network identifiers (e.g. IP addresses), telephone numbers, email addresses, etc., of content recipients in the first channel audience 108 and/or the one or more content receiving devices 112 associated there with. The first channel database 210 may also store or maintain preferences, permissions, settings, and/or a profile corresponding to one or more recipients in the first channel audience 108 and/or the one or more first content receiving devices 112 associated therewith and/or the first channel operator 106. For example, one end user or recipient (in the audience 108) may wish to fully or partially opt-in to or opt-out of receiving content via the first channel 102. One end user may wish to receive certain communications or certain content via the first channel 102. The first channel database 210 may also store or maintain access privileges, information, and/or authorization (e.g., the first channel operator 106 may be the only entity authorized to access the database 210 or may authorize the second channel operator 114 and/or third-party content sources 122 to access the database 210) and/or channel information (e.g. identity of the first channel operator 106) for or about the first channel 102. Likewise, the second channel database 212 may store or maintain identifiers or other indicators, such as network identifiers (e.g. IP addresses), telephone numbers, email addresses, etc., of content recipients in the second channel audience 116 and/or one or more second content receiving devices 120 associated therewith. The second channel database 212 may also store or maintain preferences, settings, and/or a profile corresponding to the one or more recipients in the second channel audience 116 and/or the one or more content receiving devices 120 associated therewith and/or the second channel operator 114. For example, one end user or recipient may wish to fully or partially opt-in or opt-out of receiving content via the second channel 104. One end user may wish to receive certain communications or certain content via the second channel 104. The second channel database 212 may also store or maintain access privileges, information, and/or authorization (e.g., the second channel operator 114 may be the only entity authorized to access the database 212 or may authorize the first channel operator 106 and/or third-party content sources 122 to access the database 212) and/or channel information (e.g. identity of the first channel operator 106) for or about the first channel 102.

The system 200 further includes a third-party content database 214. The third-party content database 214 may store or maintain third-party content 124 submitted, uploaded, or otherwise provided to the system 200 by one or more third-party content sources 122, the first channel operator 106 (who may be a third-party content source with respect to the second channel 104 and/or other channels), and/or the second channel operator 114 (who may be a third-party content source with respect to the first channel 102 and/or other channels). The third-party content database 214 may also store or maintain preferences, settings, permissions and/or a profile corresponding to the one or more third-party content sources 122. The third-party content database 214 may also store or maintain access privileges, information, and/or authorization for the third-party content database, particularly the third-party content 124 stored therein. The third-party content database 214 may also include information (e.g., metadata) about the third-party content 124 stored or maintained in the database 214. For example, the database 214 may include contextual information about the third-party content 124 (e.g., the content is related to sports).

While the first channel, second channel, and third-party content databases are depicted separately, it will be appreciated that they may be implemented in a different manner, such as a single database having one or more tables, on single or multiple storage devices or memories. For example, in other embodiments, each third-party source may have a corresponding third-party content database stored on the platform 202. Though not depicted herein, the system 200 may also include one or more databases operable to store or maintain content for the first and/or second channels 102, 104. Alternatively, the first and/or second channel operators 106, 114 may store the first and second content 110, 118 in one or more databases apart from the system 200. In one embodiment, the system 200 may only include one database that stores or maintains everything instead of the databases 212, 214, 216.

The platform 202 may also include a user interface 216 that allows the first channel operator 106, the second channel operator 114, the plurality of third-party content sources 122, and/or recipients in the first channel audience 108 and/or the second channel audience 116 and/or content receiving devices 112, 120 associated therewith to modify any of the previously described data or information (e.g. identifiers, settings, etc.) stored in the first channel database 210 and/or the second channel database 212 and/or add and/or remove similar information thereto/therefrom. The user interface 216 may also allow the first channel operator 106, the second channel operator 114, and/or the one or more third-party content sources 122 to access the content database 214 in order to modify, remove, or add content for distribution or transmission via the first channel 102, the second channel 104, and/or other channels.

Each first content receiving device 112 may be associated with one or more end users or recipients of the first channel audience interested in receiving first channel content 110, such as a user who registers themselves and/or their device 112 with the platform 202 or is otherwise represented in the first channel database 210. Each second content receiving device 120 may be associated with one or more end users or recipients of the second channel audience interested in receiving second channel content 118, such as a user who registers themselves and/or their device 120 with the platform 202 or is otherwise represented in the second channel database 212.

The networks 206 and 208 may be a wireless network or a combination of a wired and wireless network, such as a cellular telephone network and/or 802.11x compliant network, and may include a publicly accessible network such as the Internet, a private network, or combination thereof It will be appreciated that the type and configuration of the communications networks 206 and 208 is implementation dependent and any type of communications network which facilitates the described communications between the platform 202 and the first and/or second channel operators 106, 114, and/or the one or more third-party content sources 122 and/or the first and/or second channel audiences 108, 116, and/or the first and second content devices 112, 120, available now or later developed, may be used.

The platform 202 is operative to facilitate, based on the information, data, preferences, settings, and/or the profile stored in the first channel database 210, the transmission of first channel content 110 to the first channel audience 108 directly or indirectly via the one or more first content receiving devices 112. The platform 202 may facilitate transmission of the content 110 in response to a request received from one of the content receiving devices 118, e.g. “pull,” and/or facilitate transmit of the content 110 automatically, such as on a periodic schedule or in response to an event or other signal, e.g. “push.” Likewise, the platform 202 is operative to facilitate, based on the information, data, preferences, settings, and/or the profile stored in the second channel database 212, the transmission of second channel content 112 to the second channel audience 116 directly, or indirectly via the one or more second content receiving devices 120. The platform 202 may facilitate the transmission of the second content 118 in response to a request received from one of the content receiving devices 120, e.g. “pull,” and/or facilitate the transmission of the content 118 automatically, such as on a periodic schedule or in response to an event or other signal, e.g. “push.”

The platform 202 thus allows the first channel operator 106 to transmit his/her own content 110 via his/her channel 102. Likewise, the platform allows the second channel operator 114 to transmit his/her own content 118 via his/her channel 104. Advantageously, the platform 202 is also operable to allow communication between the first and/or second channel operators 106, 114 and/or one or more third-party content sources 122 and/or other channel operators. For example, the channel operator 106 may communicate directly with one or more third-party sources 122 via the platform 202. This direct communication allows channel operators 106, 114 to leverage their channels and/or content, and/or third-party content sources 122 to leverage their content 124, and/or other channel operators to leverage their channels/content. Channel operators 106, 114 may, in turn, enable the transmission or distribution of third-party content 124 via the first and/or second channels 102, 104, respectively. The platform 202 is also configured to allow the third-party content sources 122 to enable the transmission or distribution of their content 124 via the first and/or second channels 102, 104.

To this end, the platform 202 is operative to receive, from the first and second channel operators 106, 114, data 222 indicative of an authorization to enable, permit, or allow the transmission of third-party content 124 via the first and second channels 102, 104, respectively. The data 222 may be indicative of an authorization to enable, permit, or allow the transmission of all third-party content 124, regardless of the subject matter of the third-party content 124 and/or the third-party content source 122 associated with the third-party content 124. The data 222 may alternatively be indicative of an authorization to enable, permit, or allow the transmission of one or more portions or subsets of third-party content 124, such as only a certain type or certain types of third-party content 124, such as, for example, sports content (e.g., schedules, articles, event information) and/or financial incentives (e.g., coupons, discounts) or the transmission of third-party content 124 in specific instances (e.g., when the third-party content source is willing to pay a specific price) or under circumstances (e.g., only on the weekend). Further yet, the data 222 may be indicative of an authorization to permit, allow, or enable the transmission of third-party content 124 from a subset of third-party content sources 122, such as certain third-party content sources 122 (e.g., Moblico). In other words, the channel operators 106, 114 may choose to filter the third-party content 124 based upon the identity of the third-party content source 122 and/or the market or industry in which the third-party content source 124 does business. The data 222 may also be indicative of an authorization to enable, request, permit, or allow the transmission of specific third-party content 124, such as, for example, third-party content that the first and/or second channel operators 106, 114 have previously received or been given access to and reviewed from the third-party contact database 214 or independently of the platform 202. The data 222 may also be indicative of a request or an authorization to request the transmission of third-party content 124 via the first and second channels 102, 104, respectively. More specifically, the data 222 may be indicative of a request or an authorization to request the transmission of all or one or more subsets (see above) of third-party content 124 and/or third-party content 124 from any, all, or a subset of third-party content sources 122. In turn, the third-party content sources 122 to which the request is made and/or the third-party content sources 122 associated with the requested third-party content 124 may approve or deny the request and/or respond to the request by uploading third-party content 124. The data 222 may be manually generated by the first and second channel operators 106, 114, or may be automatically generated based on, for example, the settings, preferences, or profile of the first and/or second channel operators 106, 114 stored in the first and/or second contact databases 210, 212.

Further to this end, the platform 202 is operative to receive, from the one or more third-party content sources 122 (e.g., third-party content publishers, providers, and/or producers), both the third-party content 124 and data 224 associated with the respective third-party content 124. The data 224 is indicative of an authorization to transmit or distribute the associated third-party content 124 via the first and/or second channels 102, 104. As with the data 222, the data 224 may be indicative of an authorization to transmit or distribute the third-party content 124 over all channels or specific channels (e.g., over the first channel 102, but not over the second channel 104) based on, for example, the operator associated with that channel (e.g., the channel operator is a competitor), the target audience or demographics of the audience for that channel, and/or the cost of transmitting or distributing content via that channel. The data 224 may or may not include information or data, such as content type, subject matter, price, desired use, etc., of or for the third-party content 124. For example, the data 224 may indicate that the third-party content 124 is sports-related. The data 224 may also specify or indicate the desired use of the third-party content 124 in or via the first and/or second channels 102, 104. For example, the data 224 may indicate that the content source 122 wishes to display his/her content in a certain location / place on or in the first and/or second channels 102, 104. The data 224 may be manually generated by one or more third-party content sources 122, or may be automatically generated based on, for example, the settings, preferences, or profile of the one or more third-party content sources 122 stored in the third-party database 214.

The system 200 further includes a permission matrix 226 operable to correlate, match, align, resolve, derive, or otherwise analyze the data 222 received from each of the first and second channel operators 106, 114 with the data 224 received from each of the third-party content sources 122. Based on this permission matrix 226, the platform 202 is operative to determine when the data 222 received from the first and/or second channel operators 106, 114 correlates with the data 224 received from one or more of the third-party content sources 122. The platform 202 may determine that the data 222 from the first channel operator 106 correlates with data 224 from one or more of the third-party content sources 122 and the data 222 from the second channel operator 106 correlates with data 224 from one or more of the same or different third-party content sources. The platform 202 may also determine that only the data 222 from the first channel operator 106 or the second channel operator 114 correlates with data 224 from one of the third-party content sources 122.

When the platform 202 determines that a correlation exists between the data 222 and the data 224, the platform 202 may automatically facilitate, for each determined correlation, the distribution or transmission of the respective third-party content 124 associated with the correlated data 224, via the respective channel corresponding to the correlated data 222, to the respective content receiving device for presentation to the respective defined channel audience. For example, when the platform determines that a correlation exists between the data 222 from the first channel operator 106 and the data 224 from one third-party content source 122, the platform may automatically facilitate the distribution or transmission of the third-party content 124 associated with the data 224, via the first channel 102, to the first channel audience 108 or to the first content receiving device 112 for presentation to the first channel audience. The platform 202 may facilitate the distribution of transmission of third-party content 124 without revealing the identities of recipients in the first and/or second channel audiences 108, 116 and/or the identities of the recipients associated with the first and/or second content receiving devices 112, 120.

Alternatively, when the platform 202 determines that a correlation exists between the data 222 and the data 224, the platform 202 may notify the first channel operator 106, the second channel operator 114, and/or one or more of the third-party content sources 122 and instruct the channel operator 106, channel operator 114, and/or one or more third-party content sources 122 to review and approve the correlation. If the platform 202 receives approval from the channel operator 106, the channel operator 114, and/or one or more third-party content sources 122, the platform may then facilitate the transmission or distribution of the respective third-party content associated with the correlated data, via the respective channel corresponding to the correlated data, to the respective content receiving device for presentation to the respective defined channel audience, as described above. In one embodiment, the platform 202 may determine that the data 222 correlates with the data 224 from more than one third-party content sources 122. Accordingly, the platform 202 may select the data 224 that more highly correlates to the data 222, may select the data 224 that best corresponds with the preferences, settings, and/or profile of the first or second channel operators 106, 114, and/or may notify the first channel operator 106, the second channel operator 114, and/or one or more third-party content sources 122. The channel operators 106, 114 may, in turn, determine which data 224 to select based on, for example, the price or deal that each third-party content source 122 is willing to pay or make to transmit their third-party content 124 via the channel 102 or the channel 104. This may, for example, lead to bidding between third-party content sources 122 for the right or ability to transmit their third-party content 124 via the channel 102 or the channel 104.

The system 200 also includes a reporting system 230 operable to account for third-party content 124 transmitted or distributed via the first and/or second channels 102, 104 by, for example, measuring, collecting, or gathering content transmissions, impressions, conversions, and/or other statistics for third-party content 124 transmitted or distributed via the first and/or second channels 102, 104. The reporting system 230 may be accessed by the first channel operator 106, second channel operator 114, platform channel operator 204, and/or third-party content sources 122 via reporting tool 232. The reporting tool 232 may allow the channel operators 106, 114 and the third-party content sources 122 to determine the effectiveness or value of transmitting or distributing the third-party content 124 via the first and/or second channels 102, 104.

The system 200 is operable to calculate or derive, as a function of or based on the accounting performed by the reporting system 230 and the financial or compensation agreements, arrangements, or deals between the first channel operator 106, the second channel operator 114, and/or the third-party content sources 122 for the distribution or transmission of third-party content 124 via the first and/or second channels 102, 104, the compensation due to the channel operator 106 and/or channel operator 114 and/or third-party content source 122 and the compensation owed from the one or more third-party content sources 122 and/or first and/or second channel operators 106, 114 for the distribution or transmission of third-party content 124 via the first and/or second channels 102, 104.

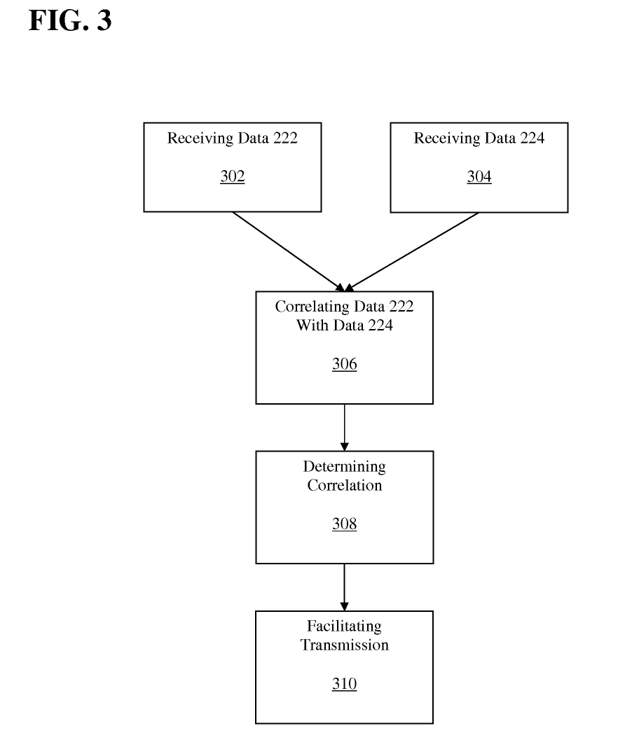

Referring to FIG. 3, there is shown a flow chart depicting the operation of the system 200 for facilitating the leveraging of first and second channels in a communication network according to one embodiment. In one embodiment, the system includes the channel network platform 202, implemented as a computer having a processor and a memory coupled thereto.

The operation or method includes transmitting from the first and second channel operators 106, 114 to, and receiving at, the platform 202 data 222 indicative of an authorization to enable the transmission of third-party content 124 via the first and second channels 102, 104, respectively (act 302). The operation or method also includes transmitting from a plurality of third-party content sources 122 (e.g., third-party content publishers, providers, and/or producers), and receiving at, the platform 202 third-party content 124 and data 224 associated with the third-party content (act 304). The data 224 is indicative of an authorization to transmit the associated third-party content 124 via the first and/or second channels 102, 104. The method further includes correlating the data 222 received from the first and second channel operators 106, 114 with the data 224 received from the plurality of third-party content sources 122 (act 306). In act 308, the system 100 determines when the data 222 received from one of the first and second channel operators 106, 114 correlates with the data 224 received from one of the plurality of third-party content sources 122. For each determined correlation, the system 100 facilitates the transmission or distribution of the respective third-party content 124 associated with the correlated data 224, via the respective channel 102, 104 corresponding to the correlated data 222, to the respective channel audience 108, 116, or to the respective content receiving device 112, 120 for presentation to the respective defined channel audience (act 310).

In one embodiment, the operation of the system 100 may further include accounting for the transmission of the third-party content 122 via the respective content channel 102, 104. This may be done by measuring, collecting, or gathering content transmissions, impressions, conversions and/or statistics for third-party content 124 transmitted or distributed via the first and/or second channels 102, 104. The operation of the system 200 then includes compensating, as a function of the accounting, the channel operator 106, 114 associated with the respective content channel 102, 104.

In one embodiment, the operation of the system 200 may further include creating or establishing the first channel database 210 and/or the second channel database 212. In turn, the operation of the system 200 may include storing or maintaining identifiers or other indicators, such as network identifiers, telephone numbers, email addresses, etc., of recipients in the first and/or second audiences 108, 116, and/or of the one or more first and second content receiving devices 112, 120 associated therewith and/or storing or maintaining preferences, settings, and/or a profile corresponding to one or more recipients in the first channel audience 108 and/or the second channel audience 116 and/or the first and/or second channel operators 106, 114.

In one embodiment, the operation of the system 200 may also include creating or establishing the third-party content database, and storing or maintaining therein third-party content 124 submitted, uploaded, or otherwise provided to the system by one or more third-party content sources 122, the first channel operator 106, and/or the second channel operator 114, and/or preferences, settings, and/or a profile corresponding to the one or more third-party content sources 122. In other embodiments, the operation of the system 200 may include creating or establishing additional databases such as, for example, one or more databases operable to store or maintain content for the first and/or second channels 102, 104.

In one embodiment, the operation of the system 200 may include providing the user interface 216 to the first channel operator 106, the second channel operator 114, third-party content sources 112, the recipients in the first channel audience 108, and/or the recipients in the second channel audience 116 so as to allow data, information, preferences, settings, and/or profiles to be added to, removed from, or modified in the first channel database 210, the second channel database 212, and/or the third-party content database 214.

Referring to FIG. 4, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. Any of the components discussed above may be a computer system 400 or a component in the computer system 400.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include a disk or optical drive unit 406. The disk drive unit 406 may include a computer-readable medium 410 in which one or more sets of instructions 412, e.g. software, can be embedded. Further, the instructions 412 may embody one or more of the methods or logic as described herein. In a particular embodiment, the instructions 412 may reside completely, or at least partially, within the memory 404 and/or within the processor 402 during execution by the computer system 400. The memory 404 and the processor 402 also may include computer-readable media as discussed above.

The present disclosure contemplates a computer-readable medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication port 918. The communication port 418 may be a part of the processor 402 or may be a separate component. The communication port 418 may be created in software or may be a physical connection in hardware. The communication port 418 is configured to connect with a network 420, external media, the display 414, or any other components in system 400, or combinations thereof The connection with the network 420 may be a physical connection, such as a wired Ethernet connection or may be established wirelessly as discussed below. Likewise, the additional connections with other components of the system 900 may be physical connections or may be established wirelessly.

The network 420 may include wired networks, wireless networks, or combinations thereof, and may be representative of the networks 206 and/or 208. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof

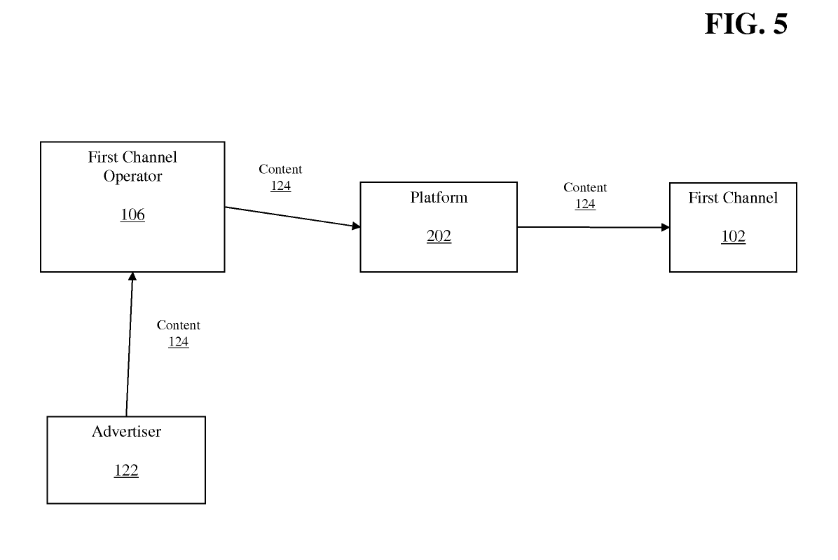

FIG. 5 illustrates one embodiment in which the system 200 facilitates the leveraging of the first channel 102 and third-party content 124. As noted above, the first channel 102 may be a mobile application, a website, a mobile website, an interactive kiosk, a stadium display, etc. In this embodiment, there is only one third-party content source 122. The third-party content source 122 is a product and/or service advertiser that produces, provides, and/or publishes third-party content 124 in the form of advertising banners for products and/or services. However, instead of using the system 200 to determine whether the first channel operator 106 has enabled and the advertiser 122 has authorized the transmission of the advertising banners 124 via the first channel 102, the first channel operator 106 and the advertiser 122 engage in direct negotiations offline or outside of the system 200. Through direct negotiations, the first channel operator 106 agrees to enable the transmission of the advertising banners 124 from the advertiser 122 via the first channel 102 and the advertiser 122 provides, and pays for, the advertising banners 124 to the first channel operator 106. In turn, the first channel operator 106 uploads the advertising banners 124 to the platform 202, which then facilitates the transmission or distribution of the advertising banners 124 via the first channel 102. The platform 202 thus, albeit in a different way, facilitates the transmission of third-party content via the first channel 102.

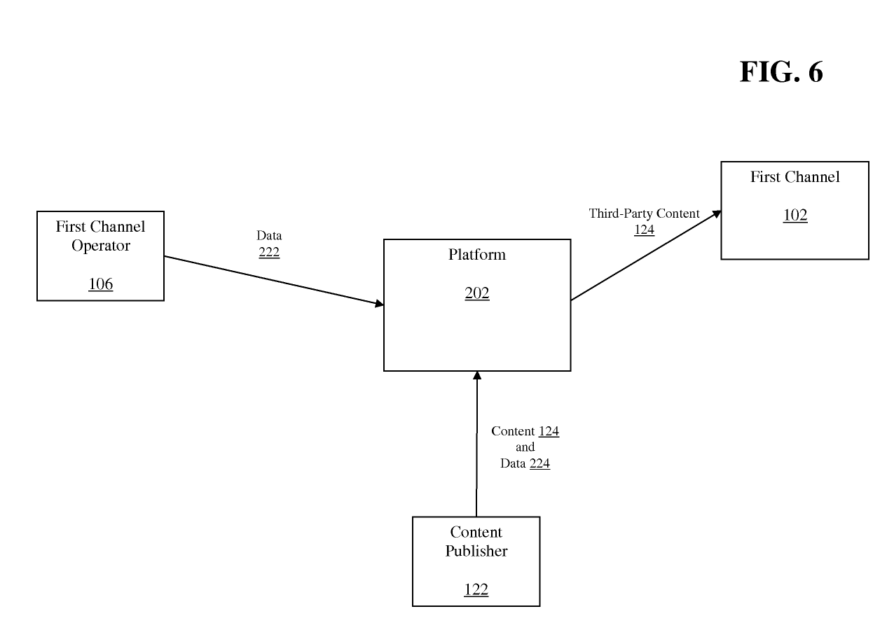

FIG. 6 illustrates another embodiment in which the system 200 facilitates the leveraging of the first channel 102 and third-party content 124. In this embodiment, the first channel 102 is a mobile website and the first channel audience 108 is defined to include registered users, consumers, and/or customers of the mobile website. The third-party content source 122 is a content publisher that publishes community relevant content 124, such as, for example, a list of upcoming community events.

In this embodiment, the first channel operator 106 wishes to enable or allow, subject to his/her final approval, the free transmission or distribution of the community content 124 published by the publisher 122 via the channel 102. Accordingly, through user interface 216 of the platform 202, the first channel operator 106 provides data 222 indicative of an authorization to enable, subject to final approval, the free transmission or distribution of the community content 124 via the first channel 102. After the content publisher 122 uploads, submits, or otherwise provides his/her community content 124 to the third-party content database 214, the content publisher 122, through the user interface 216, provides data 224 indicative of an authorization to allow or permit the transmission or distribution of the content 124 via any and all available channels, including the first channel 102. The platform 202 correlates the data 222 received from the first channel operator 106 with the data 224 received from the third-party content source 122. The platform 202, finding that the data 222 from the first channel operator 106 correlates with the data 224 from the content source 122, notifies the first channel operator 106 and instructs the operator 106 to review and approve the community content 124. If the platform 202 receives approval from the first channel operator 106, the platform 202 facilitates the transmission of the third-party content 124 via the first channel 102. Since the first channel operator 106 authorized the free transmission or distribution of the content 124 via the first channel 102, compensation between the first channel operator 106 and the content publisher 122 is not exchanged.

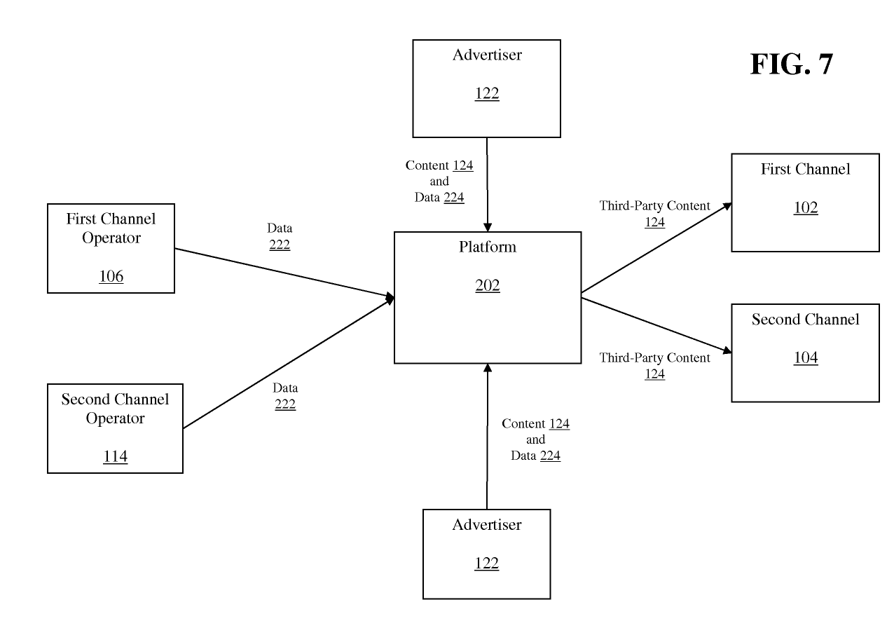

FIG. 7 illustrates one embodiment in which the system 200 facilitates the leveraging of the first channel 102, the second channel 104, and third-party content 124. In this embodiment, the first channel 102 is a mobile phone application and the first channel audience 108 is defined to include registered users of the mobile phone application. The second channel 104 is a mobile website and the second channel audience 116 comprises registered users, consumers, and/or customers of the mobile website. In this embodiment, the plurality of third-party content sources 122 comprises two product and/or service advertisers. The third-party content sources 122 in this embodiment produce, provide, and/or publish third-party content 124 in the form of product and/or service advertising, such as, for example, advertising banners for products and/or services.

In this embodiment, both the first channel operator 106 and the second channel operator 114 wish to enable or allow the transmission or distribution of all third-party advertising content 124 via their channels. Through the platform 202, particularly the user interface 216, the first channel operator 106 and the second channel operator 114 each provide data 222 indicative of an authorization to enable the transmission or distribution of all third-party advertising content 124. After the third-party content sources 122 upload, submit, or otherwise provide their advertising content to the third-party content database 214, the third-party content sources 122, through the user interface 216, each provide data 224 indicative of an authorization to allow or permit the transmission or distribution of their advertising content 124 via any and all available channels, including the first and second channels 102, 104. The platform 202 correlates the data 222 received from the first and second channel operators 106, 114 with the data 224 received from the third-party content sources 122. The platform 202, finding that the data 222 from the first channel operator 106 correlates with the data 224 from both third-party content sources 122, facilitates the transmission of the third-party content 124 from each third-party content source 122 via the first channel 102. The platform 202, finding that the data 222 from the second channel operator 114 also correlates with the data 224 from both third-party content sources 122, facilitates the transmission of the third-party content 124 from each third-party content source 124 via the second channel 104.

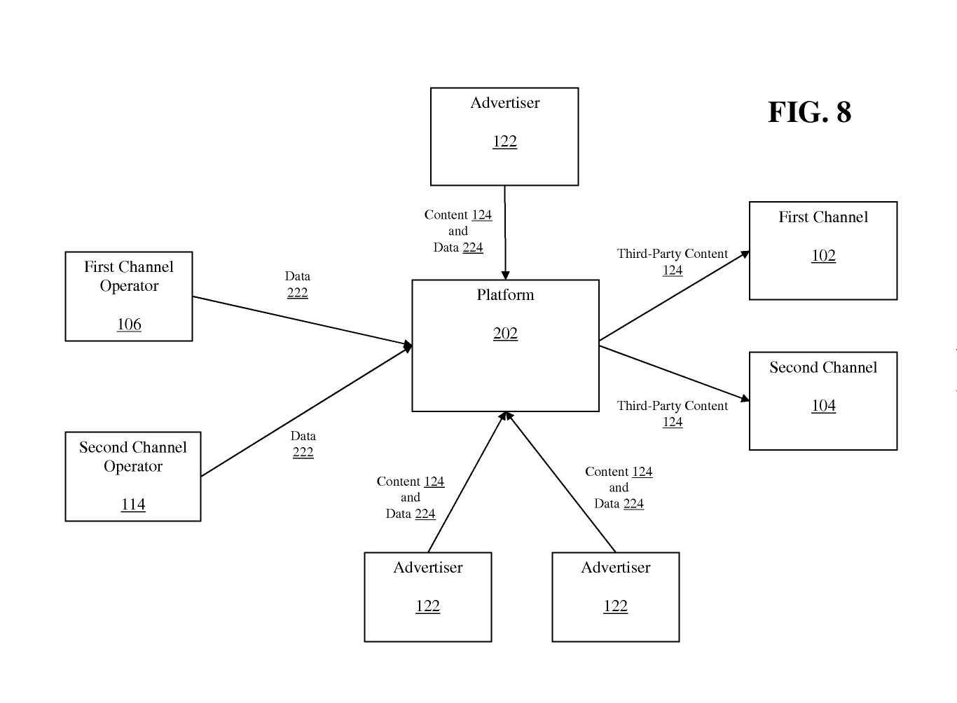

FIG. 8 illustrates one embodiment in which the system 200 facilitates the leveraging of the first channel 102 and the second channel 104. In this embodiment, the first channel 102 is a mobile phone application and the first channel audience 108 is defined to include registered users of the mobile phone application. The second channel 104 is a mobile website and the second channel audience 116 comprises registered users, consumers, and/or customers of the mobile website. In this embodiment, the one or more third-party content sources 122 comprises first, second, and third product and/or service advertisers 122. The first, second, and third product and/or service advertisers 122 produce, provide, and/or publish third-party content 124 in the form of advertising banners for products and/or services.

In this embodiment, the first channel 102 has advertising space available and the first channel operator 106 wishes to enable or allow the transmission or distribution of all third-party advertising content 124 via his/her channel 102. Through the user interface 216 of the platform 202, the first channel operator 106 provides data 222 indicative of an authorization to enable the transmission or distribution of all third-party advertising content 124. The second channel operator 114 determines that the second channel 104 has space for advertising banners. The second channel operator 114, however, determines that the second advertiser 122 is in direct competition, or has advertising content 124 that directly competes, with the channel operator 114 or content 118 provided by the channel operator 114. Accordingly, through the platform 202, the second channel operator 114 provides data 222 indicative of an authorization to enable the transmission or distribution of advertising content 124 so as long as it is not produced, provided, or published by the second advertiser 122.

In this embodiment, after the first, second, and third product and/or service advertisers 122 upload, submit, or otherwise provide their advertising banners 124 to the third-party content database 214, the first and second advertisers 122, through the user interface 216, provide data 224 indicative of an authorization to allow or permit the transmission or distribution of their advertising content 124 via the first and second channels 102, 104. The third advertiser 122, however, wishes to specifically target the recipients in the second channel audience 116. The third advertiser 122, then, provides data 224 indicative of an authorization to allow or permit the transmission or distribution of its advertising content 124 via the second channel 104.

In this embodiment, the platform 202 correlates the data 222 received from the first and second channel operators 106, 114 with the data 224 received from the first, second, and third advertisers 122. The platform 202, finding that the data 222 from the first channel operator 106 correlates with the data 224 from the first and second advertisers 122, facilitates the transmission of the advertising banners 124 from the first and second advertisers 122 via the first channel 102. The platform 202, finding that the data 222 from the second channel operator 114 correlates with the data 224 from the first and third advertisers 122, facilitates the transmission of the advertising banners 124 from the first and third advertisers 122 via the second channel 104.

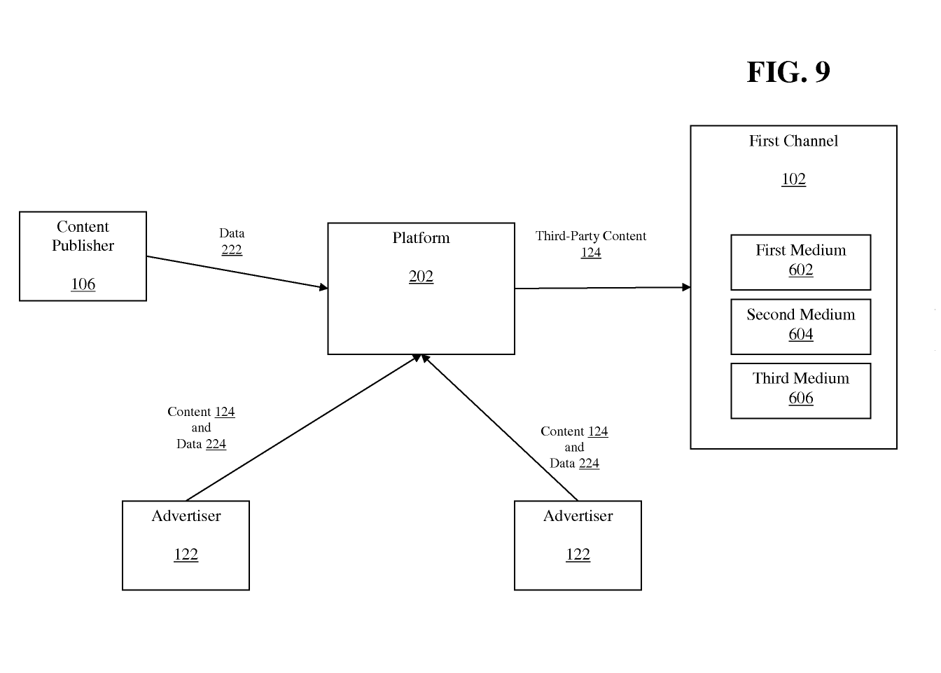

FIG. 9 illustrates one embodiment in which the system 200 facilitates the leveraging of the first channel 102 and third-party content 124. In this embodiment, the first channel operator 106 is a content publisher registered with the platform 202. The first channel 102 includes a first medium 602, a second medium 604, and a third medium 606. Each of the mediums 602, 604, 606 includes a mobile phone application, website, and mobile website. The first medium 602 is operated by a first medium operator 608, the second medium 604 is operated by a second medium operator 610, and the third medium 606 is operated by a third medium operator 612. The first, second, and third medium operators are not registered with the platform 202 but sponsor or are otherwise associated with the content publisher 106. In this embodiment, the first channel audience 108 includes the registered users, consumers, and customers of the first, second, and third mediums 602, 604, 606. The third-party content sources 122 in this embodiment are two third-party product and/or service advertisers. Each of the two third-party advertisers produces, provides, and/or publishes third-party content 124 in the form of advertising banners for products and/or services.

In this embodiment, each of the mediums 602, 604, 606 that comprise the first channel 102 has advertising space available. The first, second, and third medium operators 608, 610, 612 each wish to enable or allow the transmission or distribution of all third-party advertising content 124 via his/her respective mediums and communicates this to the content publisher 106. Through the platform 202, particularly the user interface 216, the content publisher 106 provides data 222 indicative of an authorization to enable the transmission or distribution of all third-party advertising content 124 via the first, second, and third mediums 602, 604, 606 of the first channel 102. In this embodiment, after the first and second product and/or service advertisers 122 upload, submit, or otherwise provide their advertising banners 124 to the third-party content database 214, the first and second advertisers 122, through the user interface 216, provide data 224 indicative of an authorization to allow or permit the transmission or distribution of their advertising content 124 via the first channel 102.

In this embodiment, the platform 202 correlates the data 222 received from the first, second, and third medium operators 608, 610, 612 through the content publisher 106 with the data 224 received from the first and second advertisers 122. The platform 202, finding that the data 222 from the content publisher 106 correlates with the data 224 from the first and second advertisers 122, facilitates the transmission of the advertising banners 124 from the first and second advertisers 122 via the first, second, and third mediums 602, 604, 606 of the first channel 102.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

We claim:

1. A computer implemented method for facilitating leverage of first and second channels in a communication network, the first channel associated with a first channel operator and having a first channel audience, the first channel operable to convey first channel content to a first content receiving device operable to present the first channel content to an associated recipient in the first channel audience, the second channel associated with a second channel operator and having a second channel audience, the second channel operable to convey second channel content to a second content receiving device operable to present the second channel content to an associated recipient in the second channel audience, the method comprising:
receiving, by a computer, from the first channel operator and the second channel operator, first data indicative of an authorization to enable the transmission of third-party content via the first channel and the second channel, respectively;
receiving, by the computer, from a plurality of third-party content sources, third-party content and second data associated with the third-party content, the second data indicative of an authorization to transmit the associated third-party content via the first channel and/or the second channel;
correlating, by the computer, the first data received from the first channel operator and the second channel operator with the second data received from each of the plurality of third-party content sources;
determining when the first data received from the first channel operator or the second channel operator correlates with the second data received from one of the plurality of third-party content sources; and
facilitating, for each determined correlation, the transmission, by the computer, of the respective third-party content associated with the correlated second data, via the respective channel corresponding to the correlated first data, to the respective content receiving device for presentation to the respective defined channel audience.

2. The computer implemented method of claim 1, further comprising:
accounting for the transmission of the third-party content via the respective content channel; and
compensating, as a function of the accounting, the channel operator associated with the respective content channel.

3. The computer implemented method of claim 2, wherein the accounting comprises gathering content transmissions, impressions, conversions, or combinations thereof, for the transmitted third-party content.

4. The computer implemented method of claim 1, wherein the first data received from the first channel operator correlates with the second data received from more than one of the plurality of third-party content sources, the method further comprising:
determining which third-party content source of the more than one third-party content sources is willing to pay a higher compensation to the first channel operator to transmit their respective third-party content via the first channel; and
facilitating the transmission of the third-party content associated with the third-party content source willing to pay the higher compensation, via the first channel, to the first content receiving device for presentation to the first channel audience.

5. The computer implemented method of claim 1, wherein the first data received from the first channel operator is indicative of an authorization to enable the transmission of third-party content via the first channel only after receiving approval from the first channel operator, the method further comprising:
notifying the first channel operator, before facilitating the transmission, when the first data correlates with the second data received from one of the plurality of third-party content sources; and
receiving, from the first channel operator, third data indicative of the approval from the first channel operator.

6. The computer implemented method of claim 1, wherein the first data received from the first channel operator is indicative of an authorization to enable the transmission of a subset of third-party content via the first channel.

7. The computer implemented method of claim 1, wherein the first data received from the first channel operator is indicative of an authorization to enable the transmission of only third-party content associated with a subset of the plurality of the third-party content sources.

8. The computer implemented method of claim 1, wherein the second data received from one of the plurality of third-party content sources is indicative of an authorization to transmit the associated third-party content via one of the first channel or the second channel.

9. The computer implemented method of claim 1, wherein the facilitating is performed in response to a request received from the respective content receiving device.

10. The computer implemented method of claim 1, wherein the facilitating is automatically performed in response to a signal or event.

11. The computer implemented method of claim 1, further comprising:
creating a first channel database;
receiving third data indicative of each recipient in the first channel audience; and
storing the third data in the first channel database.

12. The computer implemented method of claim 1, further comprising:
creating a first channel database;
receiving third data indicative of a profile for at least one recipient in the first channel audience; and
storing the third data in the first channel database.

13. The computer implemented method of claim 12, wherein the profile comprises an opt-in or opt-out permission for third-party content transmitted via the first channel.

14. The computer implemented method of claim 1, further comprising:
creating a first channel database;
receiving third data indicative of a profile for the first channel operator; and;
storing the third data in the first channel database.

15. The computer implemented method of claim 14, further comprising: automatically generating the first data based on the profile for the first channel operator.

16. The computer implemented method of claim 1, further comprising:
creating a third-party database;
receiving, from at least one of the plurality of third-party content sources, third data indicative of a profile for the respective at least one of the third-party content sources; and
storing the third data in the third-party database.

17. The computer implemented method of claim 16, further comprising: automatically generating, for the at least one third-party content source, the second data based on the profile for the respective at least one of the third-party content sources.

18. The computer implemented method of claim 1, further comprising:
creating a third-party database;
receiving, from at least one of the plurality of third-party content sources, third data indicative of the respective associated third-party content; and
storing the third data in the third-party database.

19. The computer implemented method of claim 18, further comprising: automatically generating, for the at least one third-party content source, the second data based on the third data.

20. A system for facilitating the leveraging of first and second channels in a communication network, the first channel associated with a first channel operator and having a first channel audience, the first channel operable to convey first channel content to a first content receiving device operable to present the first channel content to an associated recipient in the first channel audience, the second channel associated with a second channel operator and having a second channel audience, the second channel operable to convey second channel content to a second content receiving device operable to present the second channel content to an associated recipient in the second channel audience, the system comprising:
a communication platform in communication with the first channel operator, the second channel operator, a plurality of third-party content sources, the first content receiving device, and the second content receiving device,
wherein the communication platform is operable to receive, from the first channel operator and the second channel operator, first data indicative of an authorization to enable the transmission of third-party content via the first channel and the second channel, respectively, and
wherein the communication platform is operable to receive, from the plurality of third-party content sources, third-party content and second data associated with the third-party content, the second data indicative of an authorization to transmit the associated third-party content via the first channel and/or the second channel; and
a permission matrix operable to correlate the first data received from the first channel operator and the second channel operator with the second data received from each of the plurality of third-party content sources,
wherein the communication platform is operable to determine, using the permission matrix, when the first data received from the first channel operator or the second channel operator correlates with the second data received from one of the plurality of third-party content sources, and, for each determined correlation, the communication platform is operable to facilitate the transmission of the respective third-party content associated with the correlated second data, via the respective channel corresponding to the correlated first data, to the respective content receiving device for presentation to the respective defined channel audience.

21. The system of claim 20, wherein the first channel and the second channel each comprise a mobile-phone application, short message service (SMS), multimedia message service (MMS), webpage, interactive venue, electronic board, or public display device.

22. The system of claim 20, wherein the plurality of third-party content sources comprises the first channel operator or the second channel operator.

23. The system of claim 20, wherein the first channel and the second channel are created by an operator of the communication platform.

24. The system of claim 20, wherein the first channel content, the second channel content, and the third-party content comprise news, events, and/or product and service advertising or marketing.

25. The system of claim 20, further comprising a user interface operable to allow the first channel operator, the second channel operator, and/or one or more of the plurality of third-party content sources to modify, remove, or add content for transmission via the first channel or the second channel.

26. A system for facilitating the leveraging of first and second channels in a communication network, the first channel associated with a first channel operator and having a first channel audience, the first channel operable to convey first channel content to a first content receiving device operable to present the first channel content to an associated recipient in the first channel audience, the second channel associated with a second channel operator and having a second channel audience, the second channel operable to convey second channel content to a second content receiving device operable to present the second channel content to an associated recipient in the second channel audience, the system comprising a processor, a memory coupled with the processor, and a network interface operative to couple the processor with the first channel operator, the second channel operator, a plurality of third-party content sources, the first content receiving device, and the second content receiving device, the system further comprising:
first logic stored in the memory and executable by the processor to cause the processor to receive, from the first channel operator and the second channel operator, first data indicative of an authorization to enable the transmission of third-party content via the first channel and the second channel, respectively, and
second logic, coupled with the first logic, stored in the memory and executable by the processor to cause the processor to to receive, from the plurality of third-party content sources, third-party content and second data associated with the third-party content, the second data indicative of an authorization to transmit the associated third-party content via the first channel and/or the second channel; and
third logic, coupled with the second logic, stored in the memory and executable by the processor to cause the processor to correlate the first data received from the first channel operator and the second channel operator with the second data received from each of the plurality of third-party content sources,
fourth logic, coupled with the third logic, stored in the memory and executable by the processor to cause the processor to determine when the first data received from the first channel operator or the second channel operator correlates with the second data received from one of the plurality of third-party content sources; and
fifth logic, coupled with the fourth logic, stored in the memory and executable by the processor to cause the processor to facilitate, for each determined correlation, the transmission of the respective third-party content associated with the correlated second data, via the respective channel corresponding to the correlated first data, to the respective content receiving device for presentation to the respective defined channel audience.
